(19) United States
(12) Patent Application Publication
(10) Pub. No.: US 2006/0099461 A1
(43) Pub. Date: May 11, 2006

(54) Magnetic recording system with continuous lubrication of recording media

(75) Inventors: Paul Max Jones, Pittsburgh, PA (US); James Dillon Kiely, Sewickley, PA (US); Lei Li, Wexford, PA (US); Ibrahim Kursat Sendur, Pittsburgh, PA (US); Yiao-Tee Hsia, Wexford, PA (US)

Correspondence Address: Alan G. Towner;Pietragallo, Bosick & Gordon, One Oxford Centre, 38th Floor, 301 Grant Street, Pittsburgh, PA, 15219, US

(73) Assignee: Seagate Technology LLC, Scotts Valley, CA (US)

(21) Appl. No.: 10/982,370

(22) Filed: Nov. 5, 2004

(51) Int. Cl. G11B 5/65; G11B 11/00

(52) U.S. Cl. 428/835.8; 428/835.6; 428/835.7; 428/843.3; 428/825.1; 369/13.35; 369/13.56

(57) ABSTRACT

The present invention provides a self lubricating magnetic recording system that delivers lubricant molecules from a gas phase to the surface of recording media at a sufficient rate to cover the exposed media before it can interact with the writing transducer. The environment around the media surface includes lubricant vapor, and when the lubricant film is removed from the disc surface, e.g., upon heating of the medium, it is replaced by adsorption from the surrounding vapor. The lubricant is thus replenished by delivering lubricant from the vapor phase.

### GOVERNMENT CONTRACT

This invention was made with United States Government support under Agreement No. 70NANB1H3056 awarded by the National Institute of Standards and Technology (NIST). The United States Government has certain rights in the invention.

### FIELD OF THE INVENTION

The present invention relates to magnetic recording systems, and more particularly relates to a system for continuously lubricating magnetic recording media.

### BACKGROUND OF THE INVENTION

Magnetic recording in its conventional form has been projected to suffer from superparamagnetic instabilities at high bit densities. As the grain size of the magnetic recording medium is decreased in order to increase the areal density, a threshold known as the superparamagnetic limit at which stable data storage is no longer feasible is reached for a given material and temperature.

Thermal stability of magnetic recording systems can be improved by employing a recording medium formed of a material with a very high magnetic anisotropy. However, very few of such hard magnetic materials exist. Furthermore, with currently available magnetic materials, recording heads are not able to provide a sufficient magnetic writing field to write on such materials.

The current strategy to control media noise for high areal density recording is to reduce the lateral dimensions of the grains. The resulting reduction of the grain volume has to be compensated by a corresponding increase of the magnetic crystalline anisotropy energy density of the media in order to ensure thermal stability of the stored bits throughout a period of at least 10 years. Although the high magnetic crystalline anisotropy of recently developed granular media like L1₀ based FePt or CoPt supports areal densities up to several Tbit/inch², it also hinders conventional writing.

One solution to overcome this dilemma is to soften the medium temporarily by locally heating it to temperatures at which the external write field can reverse the magnetization. This concept, known as heat assisted magnetic recording (HAMR), relies on proper management of the spatial and temporal variations of the heat profile. HAMR involves locally heating a magnetic recording medium to reduce the coercivity of the recording medium in a confined region so that the applied magnetic writing field can more easily direct the magnetization of the recording medium in the region during the temporary magnetic softening of the recording medium caused by the heat source. HAMR allows for the use of small grain media, which is desirable for recording at increased areal densities, with a larger magnetic anisotropy at room temperature assuring a sufficient thermal stability.

Conventional recording media such as discs typically have a lubricating layer on the surface of the disc. However, due to high peak temperatures and fast heating rates involved in the heat assisted writing of magnetic media, traditional disc surface lubricants are either desorbed or decomposed. In such HAMR systems, as well as other types of recording systems in which high localized temperatures are exposed on the media surface, rapid and high temperatures cause rapid and complete desorption and/or decomposition of the lubricant films. The degradation or removal of the lubricant in the heat affected zone exposes the media surface to the deleterious effects such as head-disc-interactions or accelerated corrosion.

The present invention has been developed in view of the foregoing.

### SUMMARY OF THE INVENTION

The present invention provides a self lubricating magnetic recording system that delivers lubricant molecules from a gas phase to replenish a lubricating film on the surface of recording media at a sufficient rate to cover the exposed media before it can interact with the writing transducer. The environment around the media surface includes lubricant vapor, and when a portion of the lubricant film is removed from the disc surface, e.g., upon heating of the medium, it is replaced by adsorption from the surrounding vapor. The lubricant film is thus replenished by delivering lubricant from the vapor phase.

An aspect of the present invention is to provide a magnetic recording system comprising a magnetic recording medium including a lubricating surface film comprising multiple molecular layers of lubricant molecules, and a lubricant reservoir in flow communication with the magnetic recording medium, wherein depleted regions of the lubricating surface film are replenished by lubricant vapor from the lubricant reservoir.

Another aspect of the present invention is to provide a heat assisted magnetic recording system comprising a magnetic recording medium including a lubricating surface film, a heat assisted magnetic recording head positionable adjacent to the magnetic recording medium including a heat source for heating the magnetic recording medium when the recording head writes to the magnetic recording medium, and a lubricant reservoir in flow communication with the magnetic recording medium. During operation of the heat assisted magnetic recording system, depleted regions of the lubricating surface film are replenished by lubricant vapor from the lubricant reservoir.

A further aspect of the present invention is to provide a method of lubricating a magnetic recording medium. The method comprises delivering lubricant vapor from a lubricant reservoir to the magnetic recording medium to replenish a lubricating surface film on the medium comprising multiple molecular layers of lubricant molecules.

These and other aspects of the present invention will be more apparent from the following description.

### BRIEF DESCRIPTION OF THE DRAWINGS

FIG. 1 is a pictorial representation of a disc drive storage system including a heat-assisted magnetic recording head and recording medium which may be continuously lubricated in accordance with an embodiment of the present invention.

FIG. 2 is a partially schematic side view of a heat-assisted magnetic recording head and recording medium which may be continuously lubricated in accordance with an embodiment of the present invention.

FIG. 3 is a partially schematic isometric view of a heat-assisted magnetic recording head and recording medium which is continuously lubricated in accordance with an embodiment of the present invention.

FIG. 4 is a partially schematic isometric view of a portion of a lubricant reservoir.

FIG. 5 is a side sectional view of a portion of a recording medium including a lubricant film having multiple molecular layers in accordance with an embodiment of the present invention.

FIG. 6 is a graph of calculated lubricant particle impingement rate versus vapor pressure.

FIG. 7 is a graph of equilibrium lubricant film thickness versus relative vapor pressure of a lubricating fluid.

### DETAILED DESCRIPTION OF THE INVENTION

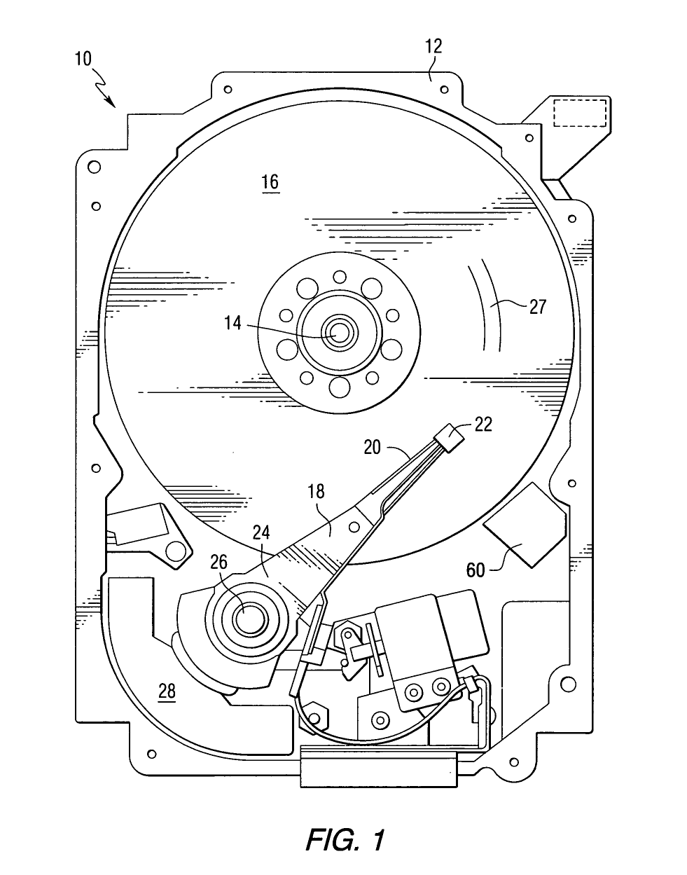

FIG. 1 is a pictorial representation of a disc drive 10 including a heat assisted magnetic recording head. The disc drive 10 includes a housing 12 (with the upper portion removed and the lower portion visible in this view) sized and configured to contain the various components of the disc drive. The disc drive 10 includes a spindle motor 14 for rotating at least one magnetic storage medium 16, which may be a perpendicular magnetic recording medium, within the housing. At least one arm 18 is contained within the housing 12, with each arm 18 having a first end 20 with a recording head or slider 22, and a second end 24 pivotally mounted on a shaft by a bearing 26. An actuator motor 28 is located at the arm's second end 24 for pivoting the arm 18 to position the recording head 22 over a desired sector or track 27 of the disc 16. The actuator motor 28 is regulated by a controller, which is not shown in this view and is well known in the art. In accordance with the present invention, a lubricant reservoir 60 may be mounted inside the housing in flow communication with the surface of the recording medium 16.

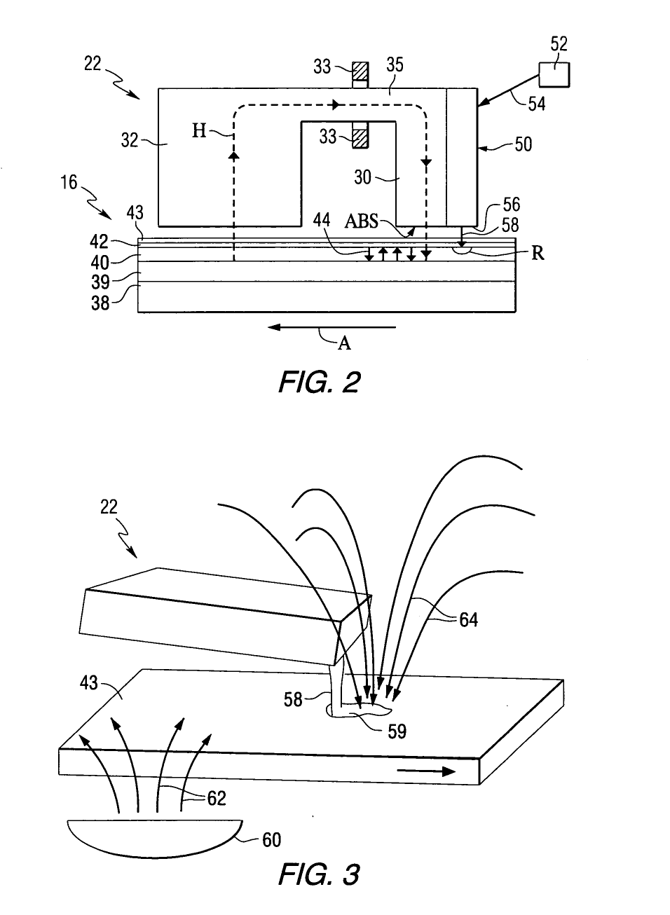

FIG. 2 is a partially schematic side view of a HAMR head 22 and a magnetic recording medium 16. Although an embodiment of the invention is described herein with reference to recording head 22 as a perpendicular magnetic recording head and the medium 16 as a perpendicular magnetic recording medium, it will be appreciated that aspects of the invention may also be used in conjunction with other type recording heads and/or recording mediums where elevated temperatures are experienced during operation of the systems. The present lubrication system may thus be used in various applications such as magnetic or other types of data recording media.

The HAMR head 22 includes a writer section comprising a main write pole 30 and a return or opposing pole 32 that are magnetically coupled by a yoke or pedestal 35. It will be appreciated that the HAMR head 22 may be constructed with a write pole 30 only and no return pole 32 or yoke 35. A magnetization coil 33 may surround the yoke or pedestal 35 for energizing the HAMR head 22. The HAMR head 22 also may include a read head, not shown, which may be any conventional type read head as is generally known in the art. The recording medium 16 is positioned adjacent to or under the recording head 22 for movement, for example, in the direction of arrow A.

As illustrated in FIG. 2, the recording head 22 also includes structure for HAMR to heat the magnetic recording medium 16 proximate to where the write pole 30 applies the magnetic write field H to the recording medium 16. Specifically, such structure for HAMR may include, for example, a planar optical waveguide schematically represented by reference number 50. The waveguide 50 is in optical communication with a light source 52. The light source 52 may be, for example, a laser diode, or other suitable laser light sources for coupling a light beam 54 into the waveguide 50. Various techniques that are known for coupling light beam 54 into the waveguide 50 may be used in conjunction with the invention, such as, for example, the light source 52 may work in association with an optical fiber and external optics, such as an integrated spherical lens, for collimating the light beam 54 from the optical fiber toward a diffraction grating (not shown). Alternatively, for example, a laser may be mounted on the waveguide 50 and the light beam 54 may be directly coupled into the waveguide 50 without the need for external optical configurations. Once the light beam 54 is coupled into the waveguide 50, the light may propagate through the optical waveguide 50 toward a truncated end 56 of the waveguide 50 that is formed adjacent the air-bearing surface (ABS) of the recording head 22. The laser light 58 is then directed toward the medium 16 where it heats the magnetic recording layer 40 in a region R beneath the waveguide 50. Such heating causes desorption or decomposition of the lubricating film 43 near the heated region R.

As shown in FIG. 2, the heat-assisted magnetic recording medium 16 includes a substrate 38, an optional soft underlayer 39, a magnetic recording layer 40 and a protective overcoat 42. A lubricant film 43 is applied on the overcoat 42. The lubricant film 43 is typically from about 10 to about 50 Å thick, for example, from about 20 to about 30 Å thick. The lubricant may have a relatively low molecular weight, e.g., less than 3,000 g/mol or 2,500 g/mol. The lubricant composition may comprise perfluoropolyethers (PFPEs) and the like, such as those sold under the designations Zdol, Z03 and Ztetraol by Solvay Solexis. When used in a heat assisted magnetic recording system, the lubricant may be selected such that it is substantially non-absorbing with respect to the laser beam. As more fully described below, the lubricant composition and molecular size, as well as the vapor pressure of the system, are controlled in order to provide a desired equilibrium thickness of the lubricant film on the recording media. As also more fully described below, the lubricant film comprises multiple molecular layers in order to provide a desired adhesion force at the outermost molecular layer.

The substrate 38 may be made of any suitable material such as ceramic glass, amorphous glass, aluminum or NiP coated AlMg. The soft underlayer 39 has a typical thickness of from about 50 to about 1,000 nm, and may be made of any suitable material such as CoFe, FeCoB, FeAlN, FeAlSi, NiFe, CoZrNb or FeTaN. The soft underlayer 39 may also comprise laminated structures such as (FeCoB/Ta)·n where n is from 2 to 10, or (FeAlSi/C)·n where n is from 2 to 10. The soft underlayer 39 may further comprise exchange biased structures such as Cu/(IrMn/FeCo)·n where n is from 1 to 5. The magnetic recording layer 40 has a typical thickness of from about 2 to about 50 nm, and may comprise materials having relatively high anisotropies at ambient temperature, such as FePt and CoCrPt alloys. A seed layer (not shown) may optionally be provided, e.g., between the soft underlayer 39 and the recording layer 40. The seed layer may have has a typical thickness of from about 1 to about 50 nm and may be used to control properties such as orientation and grain size of the subsequently deposited layers. For example, the seed layer may be a face centered cubic material such as Pt which controls the orientation of the subsequently deposited film 40, may be a material such as Ru or Rh which controls grain size and facilitates epitaxial growth of the subsequently deposited layers, or a combination thereof. The seed layer may be made of one or more layers of material such as CoCr, CoCrRu, Ru, Pt, Pd, Rh, Ta, TiC, indium tin oxide (ITO), AlN or ZnO. The protective layer 42 may be made of any suitable material such as diamond-like carbon.

FIG. 3 schematically illustrates the lubricant layer replenishment system of the present invention. The laser energy 58 from the recording head 22 heats a region 59 of the lubricating film 43. Lubricant molecules in the region 59 are either desorbed or decomposed as a result of the laser 58.

As schematically shown in FIG. 3, a lubricant reservoir 60 is provided in vapor flow communication with the surface of the lubricating film 43. In accordance with the present invention, lubricant molecules 62 are given off in vapor form from the lubricant reservoir 60. A portion of the lubricant vapor 64 is deposited in the depleted region 59 of the lubricant film 43 to thereby build up a multilayer lubricant surface film from the vapor phase.

The saturated reservoir 60 of disc lubricant may be placed at any suitable location within the disc enclosure 12. The reservoir 60 delivers a predetermined vapor pressure of lubricant inside the enclosure. Lubricant molecules thereby enter the gas phase and bombard the disc surface with a known rate principally determined by the vapor pressure. A multilayer surface film of lubricant is therefore built up from the gas phase. Equilibrium is then established between the gas phase lubricant molecules and the outermost layer of the formed multilayer surface film. The vapor pressure of the lubricant and its interaction with the surface control the thickness of this surface film.

In accordance with the present invention, the depleted region of the lubricating surface is replenished extremely quickly, e.g., typically in less than 10 milliseconds. For example, the depleted region may be replenished within from about 1 to about 5 milliseconds. For heat assisted magnetic recording, the depleted region should be substantially replenished within the time it takes the recording disc to make one rotation.

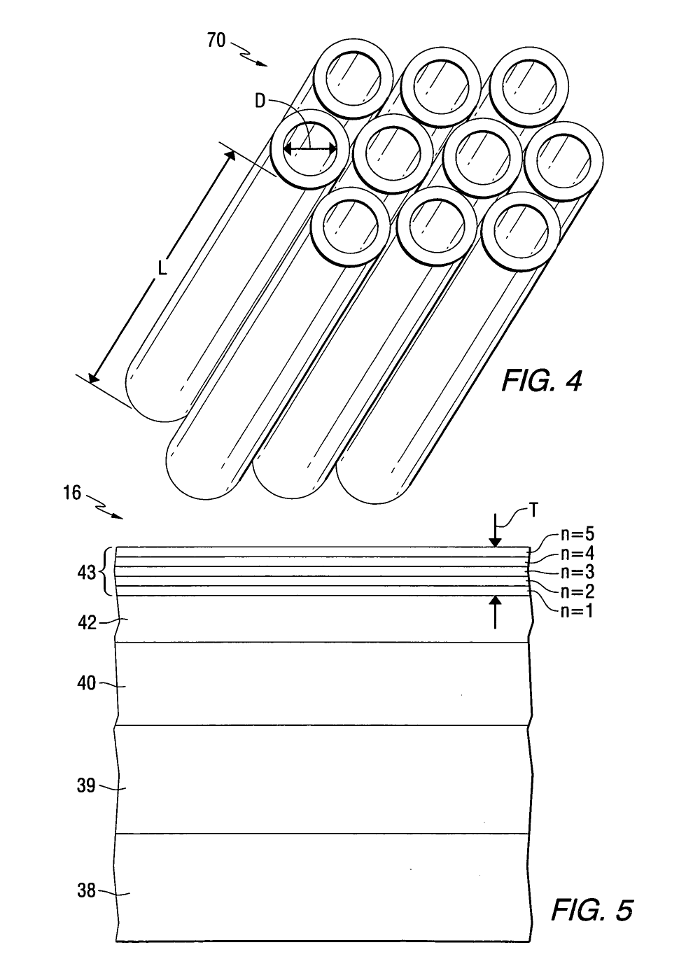

The lubricant reservoir 60 may deliver fixed vapor pressure of the saturant into the environment. One embodiment uses a nanoporous material which contains significant porosity and is composed of a non-reactive material. For example, the nanoporous material may comprise carbon nanotubes 70, as illustrated in FIG. 4. Typical dimensions for each nanotube 70 are from about 0.1 to about 10 nm in diameter D and from about 1 to about 50 nm long L. As a particular example, each nanotube 70 can be about 0.7 nm in diameter and about 10 nm long. The number of nanotubes 70 provided in the reservoir 60 may be selected in order to contain a sufficient amount of lubricant for supply to the recording media during the lifetime of the system, e.g., a minimum of at least 5 or 10 years. For example, several hundred thousand or several million nanotubes may be used.

As shown in the embodiment in FIG. 5, the lubricant layer 43 comprises multiple molecular layers of lubricant molecules labeled n=1 through n=5. The multiple molecular layers of lubricant n=1 through n=5 have a total thickness T corresponding to an equilibrium thickness determined by the composition of the lubricant and the vapor pressure of the system. The adhesive force of each layer n=1 through n=5 decreases as the distance from the upper surface of the protective overcoat 42 increases. Thus, the first molecular layer of lubricant n=1 has a very high surface adhesion force to the protective overcoat 42, while the uppermost molecular layer of lubricant n=5 has a relatively low surface adhesion force with respect to the underlying n=4 molecular layer. For a given lubricant composition and vapor pressure, the total thickness T of the lubricant layer 43 reaches a desired equilibrium point, which depends on the surface adhesion between the n=4 and n=5 molecular layers.

The operating vapor pressure within a fixed temperature range may be determined using the Kelvin equation:

$$ln ( \frac{{P}_{V}}{{P}_{0}} ) = \frac{- 2 {V}_{m} γ}{rRT}$$

where Vₘ is the molar volume of the fluid, γ the surface tension, P_{V}/P₀ is the relative vapor pressure and r the pore radius, i.e., the radius of the nanotube opening. When a nanoporous material is used in the lubricant reservoir, by controlling the pore radius and the material properties of the fluid, a desired vapor pressure may be delivered to the media enclosure.

As the pressure is increased, the pores or channels are filled hierarchically by size. The extent of filling of the reservoir depends on the surface tension, γ, of the lubricant and its partial pressure of P_{V}/P₀. Exposure to increasing partial pressures of the lubricant fills the nanotube reservoir. X-ray reflectivity may be used to monitor this filling.

After filling of the nanotube reservoir, the entire structure may be placed in the recording system environment, typically at a position of large air mixing. This position is likely to be along the wall of a standard enclosure. In one embodiment, the filled nanotubes may be deposited onto the smooth portion of a tape structure and affixed to the internal wall of the hard drive in an area that has good air volume exposure. After being placed into the enclosure, the lubricant molecules filling the nanotubes diffuse through the material and assert an equilibrium P_{V}/P₀ and thus an equilibrium lubricant film on the media surface.

The efficacy of this lubrication technique depends on the size of the nanotubes. For example, the relative vapor pressure P_{V}/P₀ may be maintained at a value of at least about 0.65 in order to support an adequate film thickness. This requires a maximum nanotube pore radius of about 50 nm. Furthermore, due to the extremely large internal surface area of carbon nanotubes, large amounts of lubricant may be loaded into them, providing a nearly infinite reservoir of lubricant. In addition, carbon nanotubes have extremely high molecular diffusivity, enabling adequate transport of the lubricant through the nanotube into the recording system environment.

Once the nanotube reservoir is filled, the thermodynamics of the desorption from the tube may be governed by an augmented Kelvin equation, known as the Derjaguin equation:

$$RT ln ( \frac{{P}_{0}}{{P}_{V}} ) = \frac{2 γ {V}_{L} + \frac{2 {V}_{L}}{( {R}_{P} - {h}_{e} )} {\int }_{{h}_{e}}^{{R}_{P}} ( {R}_{P} - h ) Π ( h ) ⅆ h}{{R}_{P} - {h}_{e}}$$

where, hₑ is the equilibrium thickness of the adsorbed film, V_{L} is the molar volume, γ is the surface tension of the lubricant, Rp is the mean pore diameter and Π is the disjoining pressure. Integration of this equation, subject to the assumption that the hₑ will be significantly smaller than Rₚ and that Π varies only slowly with h, yields:

$$RT ln ( \frac{{P}_{0}}{{P}_{V}} ) \approx \frac{c}{Δ} ( 1 + \frac{2}{γ Δ} {R}_{P}^{2} Π ( {h}_{e} ) )$$

where c is 2γV_{L} and Δ is Rₚ-hₑ. To obtain hₑ, it is necessary to utilize the adsorption form of this equation, which yields an hₑ of 1.67 nm (significantly smaller than the pore diameter). Use of the augmented Kelvin equation and this equilibrium value yields a P_{V}/P₀ of 0.645, extremely close to the desired 0.65 partial pressure. Thus, with a nanotube reservoir composed of 50 nm pore radius tubes, loaded at a nearly saturated partial pressure, a˜0.65 P_{V}/P₀ will be delivered to the recording system environment. Once loaded, the reservoir delivers the correct vapor phase concentration of lubricant which, through thermodynamic equilibrium, maintains the proper multi-layer lubricant thickness on the disc or other recording medium.

The lubricant molecule impingement rate on the disc surface corresponds to the formula:

$$Φ = 3.513 ⨯ {10}^{22} [ {P}_{V} / {( MT )}^{\frac{1}{2}} ]$$

where Φ is the rate at which molecules (having a molecular mass M, temperature T and vapor pressure P_{V}) strike an element of the surface (cm²) per second. Thus determination of the fluid vapor pressure-temperature dependence and its molecular weight will allow its impingement rate to be calculated.

FIG. 6 presents a calculated impingement rate for a vapor pressure in the range 10⁻⁵ to 10⁻⁴ torr, with a lubricant molecular weight of approximately 2,000 g/mol and a temperature of 350K. These parameters are representative of typical lower molecular weight disc lubricants commonly in use in the hard drive industry. Thus, a 1 mm×1 mm area (0.01 cm²) will be completely covered by the impinging molecules in approximately 1-5 milliseconds, whereas at 10,000 rpm, approximately 6 msec is needed to fully denude a written area before the slider traverses the same spot-again. This calculation assumes diffusive mixing and represents a worst case replenishment scenario since the spinning disc is a highly effective air pump.

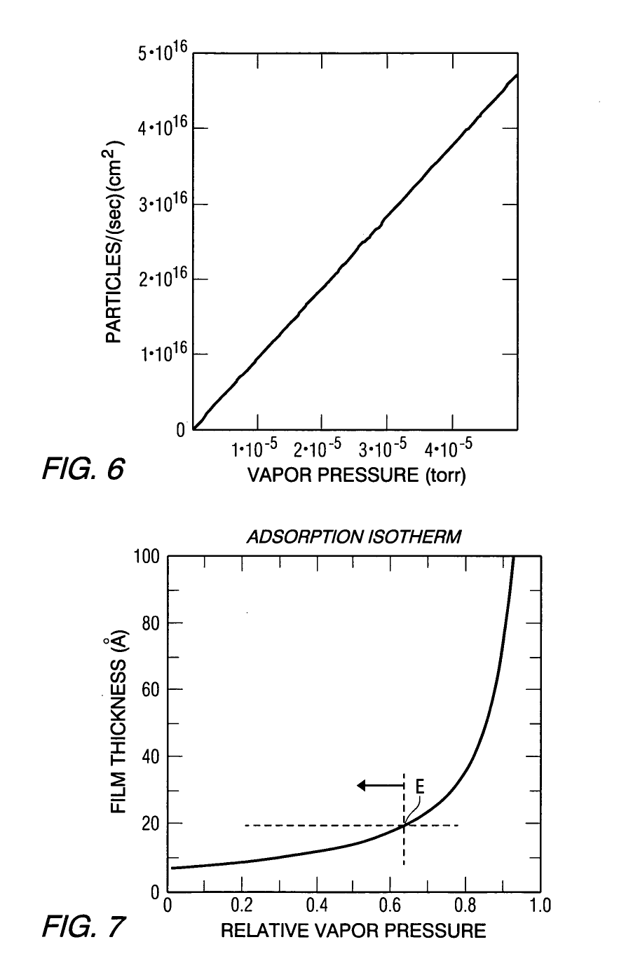

The equilibrium film thickness on the media surface is a function of the vapor pressure of the lubricating fluid used. FIG. 7 presents the calculated coverage of a typical perfluoropolyether (PFPE) lubricant having a molecular weight of approximately 2,000 g/mol. This calculation assumes Brunauer-Emmett-Teller (BET) behavior and is known to be reasonably accurate for sub-saturation vapor pressure (P_{V}/P₀<0.8). Thus, maintaining a relative vapor pressure of about 0.62 will deliver a film thickness of about 20 Å. Furthermore, due to the high impingement rate and effective mixing at the head-disc-interface (HDI) the film may typically be established in less than about 5 milliseconds.

The present continuous lubrication system provides an essentially inexhaustible supply of vapor phase lubricant, a clean source of lubricant and a controllable and reproducible lubricant supply. The system further replenishes lubricant that is removed by an irradiation source on the media surface. By providing multiple molecular layers of lubricant, the adhesion force between the uppermost layer of lubricant molecules and the next underlying layer of lubricant molecules is less than the adhesion force between the lower layers. The multi-layer lubricant film provides advantages over mono-molecular lubricant films which comprise a single molecular layer of lubricant on the underlying substrate. Multiple molecular layers of lubricant allow for the use of relatively low molecular weight lubricant molecules which can be quickly deposited while still allowing the buildup of a sufficiently thick lubricant film on the substrate.

Whereas particular embodiments of this invention have been described above for purposes of illustration, it will be evident to those skilled in the art that numerous variations of the details of the present invention may be made without departing from the invention as defined in the appended claims.

What is claimed is:

1. A magnetic recording system comprising:
a magnetic recording medium including a lubricating surface film comprising multiple molecular layers of lubricant molecules; and
a lubricant reservoir in flow communication with the magnetic recording medium, wherein depleted regions of the lubricating surface film are replenished by lubricant vapor from the lubricant reservoir.

2. The magnetic recording system of claim 1, wherein the lubricating surface film comprises from 2 to 10 of the layers of lubricant molecules.

3. The magnetic recording system of claim 1, wherein the lubricating surface film has a thickness of at least about 20 Å.

4. The magnetic recording system of claim 1, wherein the lubricating surface film has a molecular weight of less than 3,000 g/mol.

5. The magnetic recording system of claim 1, wherein the lubricating surface film comprises perfluoropolyether.

6. The magnetic recording system of claim 1, wherein the lubricant reservoir comprises a nanoporous material.

7. The magnetic recording system of claim 1, wherein the lubricant reservoir comprises nanotubes.

8. The magnetic recording system of claim 7, wherein the nanotubes have diameters of from about 0.1 to about 10 nm and lengths of from about 1 to about 50 nm.

9. The magnetic recording system of claim 1, wherein the lubricant reservoir is maintained at substantially the same temperature as the magnetic recording medium.

10. The magnetic recording system of claim 1, wherein the system is maintained substantially at atmospheric pressure.

11. The magnetic recording system of claim 1, wherein the depleted region of the lubricating surface film is replenished within about 10 milliseconds.

12. The magnetic recording system of claim 1, wherein the depleted region of the lubricating surface film is replenished within from about 1 to about 5 milliseconds.

13. The magnetic recording system of claim 1, wherein the system is a heat assisted magnetic recording system.

14. The magnetic recording system of claim 13, wherein the depleted region of the lubricating surface film corresponds to a heated region where a laser beam of the heat assisted magnetic recording system has desorbed or decomposed a portion of the lubricating surface film.

15. The magnetic recording system of claim 14, wherein the desorbed or decomposed portion of the lubricating surface film is replenished within 10 milliseconds.

16. The magnetic recording system of claim 14, wherein the desorbed or decomposed portion of the lubricating surface film is replenished within from about 1 to about 5 milliseconds.

17. The magnetic recording system of claim 13, wherein the lubricating surface film is substantially non-absorbing with respect to a laser beam generated by the heat assisted magnetic recording system.

18. A heat assisted magnetic recording system comprising:
a magnetic recording medium including a lubricating surface film;
a heat assisted magnetic recording head positionable adjacent to the magnetic recording medium, the heat assisted magnetic recording head comprising a heat source for heating the magnetic recording medium when the recording head writes to the magnetic recording medium; and
a lubricant reservoir in flow communication with the magnetic recording medium, wherein depleted regions of the lubricating surface film are replenished by lubricant vapor from the lubricant reservoir.

19. The heat assisted magnetic recording system of claim 18, wherein the lubricating surface film comprises multiple molecular layers of lubricant molecules.

20. A method of lubricating a magnetic recording medium, the method comprising delivering lubricant vapor from a lubricant reservoir to the magnetic recording medium to replenish a lubricating surface film on the medium comprising multiple molecular layers of lubricant molecules.
